(19) United States
(12) Patent Application Publication
(10) Pub. No.: US 2014/0083237 A1
(43) Pub. Date: Mar. 27, 2014

(54) CONTROL APPARATUS FOR AIR CONDITIONING SYSTEM OF VEHICLE

(71) Applicants: HYUNDAI MOTOR COMPANY, Seoul (KR); KIA MOTORS CORP., Seoul (KR)

(72) Inventor: Myung Hoe Kim, Seoul (KR)

(73) Assignees: Kia Motors Corp., Seoul (KR); Hyundai Motor Company, Seoul (KR)

(21) Appl. No.: 13/687,496

(22) Filed: Nov. 28, 2012

(30) Foreign Application Priority Data
Sep. 21, 2012 (KR) 10-2012-0105474

(51) Int. Cl. G05G 1/10

(52) U.S. Cl. CPC G05G 1/10
USPC 74/501.6

(57) ABSTRACT

A control apparatus for an air conditioning system of a vehicle, may include a knob selectively rotatable by a user's operation, a cam to which an inner wire of a cable may be connected, the cam being rotated through a rotation force transmitted from the knob, a cable holder that holds and supports a skin layer of the cable slidably surrounding the inner wire of the cable, wherein the cable holder may be pivotally coupled to a vehicle body.

### CROSS-REFERENCE TO RELATED APPLICATION

The present application claims priority to Korean Patent Application No. 10-2012-0105474, filed on Sep. 21, 2012, the entire contents of which is incorporated herein for all purposes by this reference.

### BACKGROUND OF THE INVENTION

1. Field of the Invention

The present disclosure relates to a control apparatus for an air conditioning system of a vehicle, and more particularly, to a mechanism for transmitting control force with respect to a selection of air conditioning mode by a user to an air conditioner.

2. Description of-Related Art

A control apparatus for an air conditioning system of a vehicle is configured that various air conditioning modes are selected in accordance to a user's intention wherein when a user selects various modes such as a defrost mode, a vent mode, a floor mode and a mix mode with a simple knob control, the control force is transmitted to an air conditioner and the air conditioner is converted into the selected mode.

In a prior control apparatus for an air conditioning system, when a user rotates a knob, the rotation displacement of the knob is transmitted to an air conditioner as a rotation displacement or a linear displacement of cable to set the selected mode. Here, a rotation range of the knob is limited generally to 300 degree or less and thus a converting between the modes allotted at both ends among the allotted modes by a rotation of a knob is performed inconveniently by rotating reversely the knob to 180 degree or more.

The reason for limiting a rotation range of a knob to as described above is that a cable for transmitting a rotation force of a knob can be bent or twisted excessively when the knob is rotated to 360 degree or more.

Further, in the prior control apparatus for an air conditioning system, an excessive bending of a cable is caused when the knob is rotated thereby reducing a manipulating feeling and decreasing durability.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a control apparatus for an air conditioning system of a vehicle in which a knob provided for selecting air conditioning modes can be rotated to 360 degree or more and thus the air conditioning modes arranged on the knob can be selected freely and easily and further a bending or twisting of the cable for transmitting control force produced by a control of the knob can be minimized thereby improving a control feeling and durability of the knob.

In an aspect of the present invention, a control apparatus for an air conditioning system of a vehicle may include a knob selectively rotatable by a user's operation, a cam to which an inner wire of a cable is connected, the cam being rotated through a rotation force transmitted from the knob, a cable holder that holds and supports a skin layer of the cable slidably surrounding the inner wire of the cable, wherein the cable holder is pivotally coupled to a vehicle body.

A rotation axis of the cable holder is provided in parallel to a rotation axis of the cam.

The cam is engaged with the knob via a plurality of gears disposed therebetween, wherein the cam receives the rotation force from the knob through the plurality of gears while an end of the inner wire is connected rotatably to a front end of the cam projected in a radial direction from a rotation axis of the cam.

The cam is formed integrally with a bevel gear portion around a rotation axis of the bevel gear portion, and a pinion gear provided with a bevel gear that is meshed with the bevel gear portion of the cam.

A rotation axis of the pinion gear is aligned in parallel to a rotation axis of the knob.

The cable holder may include a holder portion that fixes the skin layer of the cable by surrounding the skin layer, and a shaft projection portion that protrudes integrally from the holder portion and is configured to be inserted into an opening of the vehicle body for rotatably supporting the holder portion.

The shaft projection portion of the cable holder is formed with a flange protruding outwards and a plurality of grooves are formed in a longitudinal direction of the shaft projection portion, and the flange of the shaft projection portion is inserted elastically into the opening that rotatably supports the holder portion.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and may include hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that may have two or more sources of power, for example both gasoline-powered and electric-powered vehicles.

The methods and apparatuses of the present invention may have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating main components of a control apparatus for an air conditioning system according to an exemplary embodiment of the preset invention.

FIG. 2 is a perspective view illustrating main components of a control apparatus for an air conditioning system, as shown in an opposite direction to FIG. 1.

FIG. 3 is a view illustrating operation angles and strokes about 6 modes allotted in accordance to a cam rotation in the control apparatus as shown in FIG. 1.

FIG. 4 is a view illustrating a connection state for transmitting a control force from a control apparatus for air conditioning system to a control apparatus though a cable.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

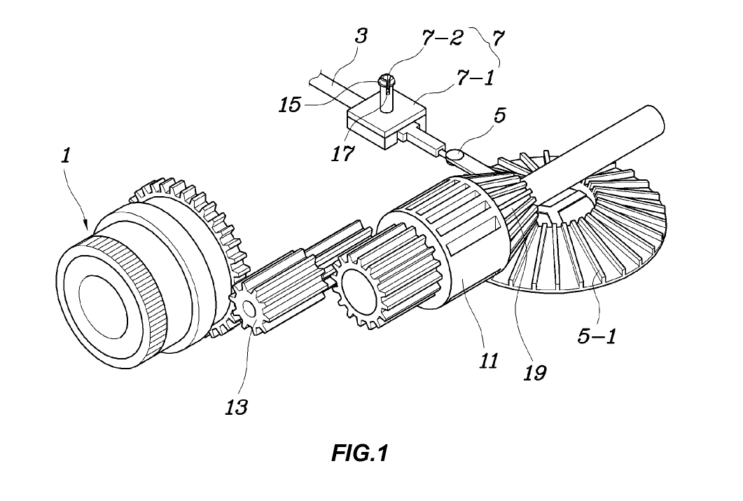

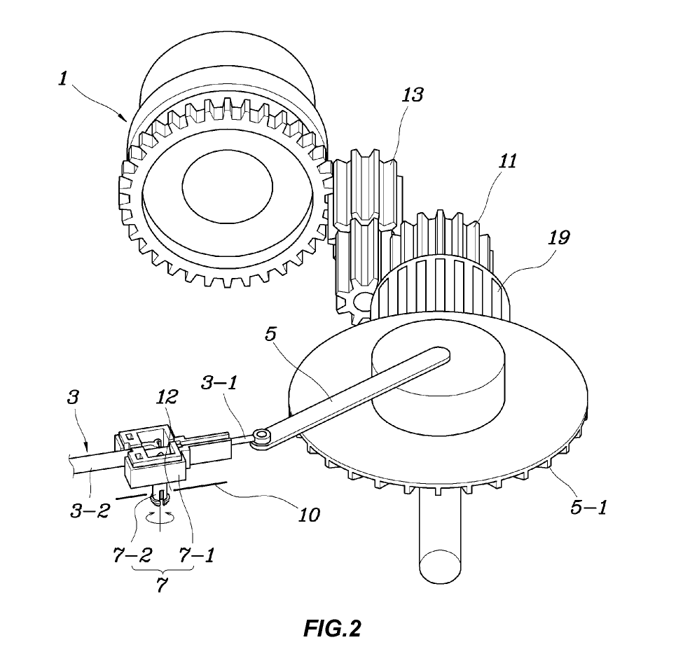

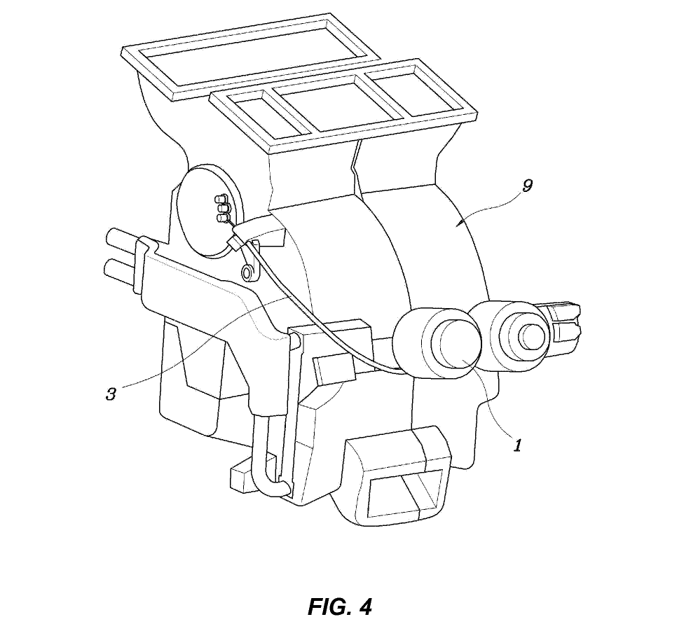

Referring to FIGS. 1 to 4, a control apparatus for an air conditioning system according to an exemplary embodiment or the present invention includes a knob 1 that is rotated by a user control, a cam 5 which is rotated through the rotation force transmitted from the knob 1 and to which an inner wire 3-1 of a cable 3 is connected, a cable holder 7 that holds and supports a skin layer 3-2 slidably surrounding the inner wire 3-1 of the cable 3 and is provided rotatably on a rotation shaft parallel to a rotation shaft of the cam 5.

The cam 5 receives a rotation force from the knob 1 through a plurality of gears while the inner wire 3-1 of the cable 3 is connected rotatably each other to a front end projected in a radial direction around the rotation shaft of the cam 5.

That is, the rotation force of the knob 1 produced by a user control is transmitted to the cable through the cam 5 and then transmitted to an air conditioner 9 wherein the inner wire 3-1 of the cable 3 and the cam 5 are connected each other rotatably and the cable 3 is supported by the cable holder 7 having a rotation shaft parallel to a rotation shaft of the cam 5, and thus angle changes of the cam that is produced by the inner wire 3-1 of the cable 3 being drawn or pushed is absorbed by the cable holder 7 while it is being rotated. Accordingly, the cable 3 cannot be bent or twisted excessively while the knob is rotated to 360 degree or more.

Here, in the control apparatus for an air conditioning system the cam 5 is formed integrally with a bevel gear portion 5-1 around a rotation shaft of the cam 5, and a pinion gear 11 provided with a bevel gear 19 that is meshed with the bevel gear portion 5-1 of the cam 5, having a rotation shaft parallel to the rotation shaft of the knob 1 and receiving a rotation force from the knob 1 is further provided. In the present embodiment, a media gear 13 for connecting the knob 1 and the pinion gear 11 is further provided wherein the rotation force from the knob 1 is transmitted by using a plurality of gears so that control force of sufficient stroke is transmitted to the inner wire 3-1 of the cable 3 while solving a narrow space around the knob 1.

Meanwhile, the cable holder 7 may include a holder portion 7-1 that fixes the skin layer 3-2 of the cable 3 by surrounding it and a shaft projection portion 7-2 that protrudes integrally from the holder portion 7-1 and is inserted into an opening 12 for supporting rotatably the holder portion 7-1 to serve as a rotation shaft.

That is, the cable holder 7 may be assembled into a vehicle body 10 by inserting the shaft projection portion 7-2 into an opening formed on the vehicle body when a vehicle is assembled.

In the present embodiment, the shaft projection portion 7-2 of the cable holder 7 is formed with a flange 15 wherein its front end is opened outward and a plurality of grooves 17 are formed in a protruded-longitudinal direction, and the shaft projection portion is inserted elastically into an opening that supports rotatably the holder portion 7-1 and is prevented being disengaged from the opening after insertion due to its snap fit configuration. Accordingly, the cable holder can be assembled simply only by inserting the shaft projection portion into an opening formed in a vehicle body with pressing it.

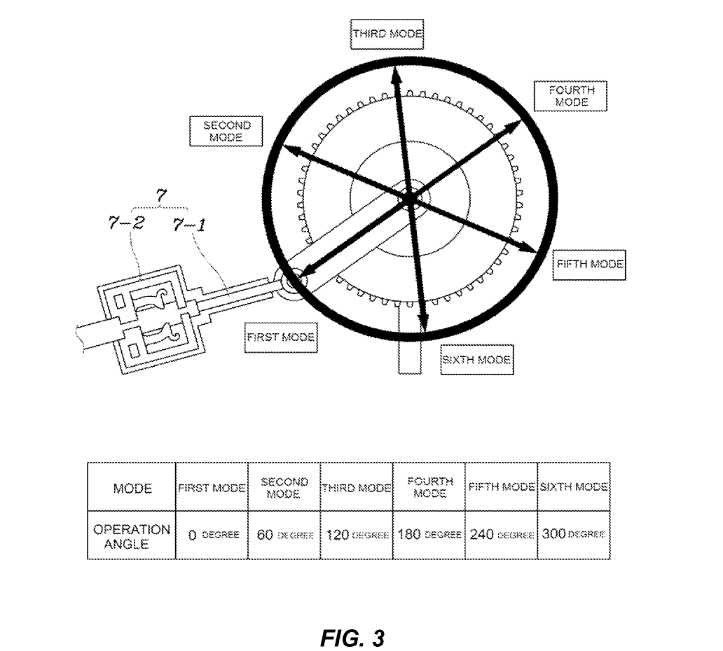

Referring to FIG. 3, a first mode to a sixth mode are allotted in accordance to the rotation angle of the cam 5 that is rotated with a rotation force from the knob 1 wherein the cam 5 is rotated to 360 degree or more bilaterally without a directional property by a control of the knob 1 to select a desired mode.

That is, each mode is to be allotted in accordance to a rotation angle of the cam 5 and the respective strokes drawing the inner wire 3-1 of the cable 3 are formed differently in accordance to the rotation angle of the cam 5, and the control signals for the allotted first to sixth modes are divided by the different strokes each other per mode. Accordingly, the respective modes are implemented on the air conditioner 9 through the cable 3 connected to the cam 5.

Of course, a defrost mode, a vent mode, a floor mode and a mix mode, etc., may be allotted on the first to sixth modes wherein the number of the mode may be increased or decreased.

According to the control apparatus for an air conditioning system, a knob provided for selecting air conditioning modes can be rotated to 360 degree or more and thus the air conditioning modes arranged on the knob can be selected freely and easily and further a bending or twisting of the cable for transmitting control force produced by a control of the knob can be minimized thereby improving a control feeling and durability of the knob.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control apparatus for an air conditioning system of a vehicle, comprising:
a knob selectively rotatable by a user's operation;
a cam to which an inner wire of a cable is connected, the cam being rotated through a rotation force transmitted from the knob;
a cable holder that holds and supports a skin layer of the cable slidably surrounding the inner wire of the cable, wherein the cable holder is pivotally coupled to a vehicle body.

2. The control apparatus for the air conditioning system of the vehicle of claim 1, wherein a rotation axis of the cable holder is provided in parallel to a rotation axis of the cam.

3. The control apparatus for the air conditioning system of the vehicle of claim 1,
wherein the cam is engaged with the knob via a plurality of gears disposed therebetween, and
wherein the cam receives the rotation force from the knob through the plurality of gears while an end of the inner wire is connected rotatably to a front end of the cam projected in a radial direction from a rotation axis of the cam.

4. The control apparatus for the air conditioning system of the vehicle of claim 3,
wherein the cam is formed integrally with a bevel gear portion around a rotation axis of the bevel gear portion, and
wherein a pinion gear provided with a bevel gear that is meshed with the bevel gear portion of the cam.

5. The control apparatus for the air conditioning system of the vehicle of claim 4, wherein a rotation axis of the pinion gear is aligned in parallel to a rotation axis of the knob.

6. The control apparatus for the air conditioning system of claim 1, wherein the cable holder includes:
a holder portion that fixes the skin layer of the cable by surrounding the skin layer; and
a shaft projection portion that protrudes integrally from the holder portion and is configured to be inserted into an opening of the vehicle body for rotatably supporting the holder portion.

7. The control apparatus for the air conditioning system of claim 6,
wherein the shaft projection portion of the cable holder is formed with a flange protruding outwards and a plurality of grooves are formed in a longitudinal direction of the shaft projection portion, and
wherein the flange of the shaft projection portion is inserted elastically into the opening that rotatably supports the holder portion.
